(19) United States
(12) Patent Application Publication
(10) Pub. No.: US 2004/0109298 A1
(43) Pub. Date: Jun. 10, 2004

(54) Dielectric material including particulate filler

(76) Inventors: William F. Hartman, Albuquerque, NM (US); Kirk M. Slenes, Albuquerque, NM (US); Kristen J. Law, Scottsdale, AZ (US)

Correspondence Address: PEACOCK MYERS AND ADAMS P C, P O BOX 26927, ALBUQUERQUE, NM, 871256927

(21) Appl. No.: 10/644,386

(22) Filed: Aug. 19, 2003

Related U.S. Application Data
(63) Continuation-in-part of application No. 09/458,363, filed on Dec. 9, 1999, now Pat. No. 6,608,760.
Application No. 09/458,363 is a continuation-in-part of application No. 09/305,253, filed on May 4, 1999, now Pat. No. 6,616,794.
(60) Provisional application No. 60/084,104, filed on May 4, 1998.

(30) Foreign Application Priority Data
May 3, 2000 (WO) PCT/US00/12002

(51) Int. Cl. C04B 35/468

(52) U.S. Cl. 361/762; 156/306.9

(57) ABSTRACT

A dielectric substrate useful in the manufacture of printed wiring boards is disclosed wherein the dielectric substrate comprises at least one organic polymer having a T_{g} greater than 140° C. and at least one filler material. The dielectric substrate of this invention has a dielectric constant that varies less than 15% over a temperature range of from −55 to 125° C. Additionally, a method for producing integral capacitance components for inclusion within printed circuit boards. Hydrothermally prepared nanopowders permit the fabrication of very thin dielectric layers that offer increased dielectric constants and are readily penetrated by microvias. Disclosed is a method of preparing a slurry or suspension of a hydrothermally prepared nanopowder and solvent. A suitable bonding material, such as a polymer is mixed with the nanopowder slurry, to generate a composite mixture that is formed into a dielectric layer. The dielectric layer may be placed upon a conductive layer prior to curing, or conductive layers may be applied upon a cured dielectric layer, either by lamination or by metallization processes, such as vapor deposition or sputtering.

This application is a continuation-in-part application of U.S. patent application Ser. No. 09/458,363, entitled “Dielectric Material Including Particulate Filler”, filed on Dec. 9, 1999, which is a continuation-in-part application of U.S. patent application Ser. No. 09/305,253, entitled “Integral Capacitance for Printed Circuit Board Using Dielectric Nanopowders”, of William F. Hartman, Kirk M. Slenes, and Kristen J. Law, filed on May 4, 1999, which claims the benefit of the filing of U.S. Provisional Patent Application Serial No. 60/084,104, entitled “Integral Capacitance for Printed Circuit Board Using Hydrothermal Dielectric Nanopowders”, filed on May 4, 1998, and the specifications thereof are incorporated herein by reference. This application also claims priority to PCT Application “Serial No. PCT/US00/12002, entitled “Dielectric Material Including Particulate Filler”, filed on May 3, 2000, and the specification thereof is incorporated herein by reference.

### BACKGROUND OF THE INVENTION

1. Field of the Invention (Technical Field):

The present invention relates to a dielectric substrate useful in the manufacture of printed wiring boards wherein the dielectric substrate comprises at least one organic polymer having a T_{g} greater than 140° C. and at least one filler material. The dielectric substrate of this invention has a dielectric constant that varies less than 15% over a temperature range of from −55 to 125° C. This invention also includes multilayer printed circuit boards including dielectric substrates of this invention and especially printed circuit boards wherein the dielectric substrate of this invention is used to form internal distributed capacitors in the printed circuit board.

The present invention further relates to providing capacitance in printed circuit boards, more specifically to a method and apparatus for providing a layer or layers of integral capacitance in printed circuit boards using dielectric nanopowders.

2. Background Art

Multilayer printed wiring boards (PWB's) are widely used in electronic devices such as computers, telephones, appliances, automobiles and the like. Multilayer printed wiring boards typically include a board having a plurality of insulated conductive trace layers separated by dielectric substrate layers. Due to the demand for smaller and smaller electronic devices, efforts have been made to incorporate circuit devices directly into printed wiring boards. For example, U.S. Pat. No. 5,010,641 discloses a multilayer printed wiring board including internal distributed capacitors. Similarly, U.S. Pat. Nos. 5,155,655 and 5,161,060 disclose capacitor laminates useful in the manufacture of capacitive printed wiring boards.

The capacitors built into printed wiring boards typically include a metal ground layer and a charged metal layer divided by a dielectric substrate layer. The dielectric layers used in printed wiring board capacitors are generally polymeric sheets that may be reinforced with materials such as glass, ceramics and so forth. More recently, there has been a trend towards reducing the profile of circuits and dielectric layers in printed wiring boards in order to increase printed wiring board circuit density. This trend has resulted in the reduction of the thickness of dielectric layers associated with wiring board capacitors. However, a problem with reducing the thickness of capacitor dielectric layers is that the dielectric constant of the dielectric layer varies too widely with varying temperatures causing undesirable variable capacitance. Therefore, there remains the need for dielectric substrate layers that are useful in forming printed wiring board capacitors that are thin and have dielectric constants that vary little over a wide temperature range.

Furthermore, printed circuit boards (PCBs) typically are constructed in a laminated form. Several layers of laminate are used in a board for providing electrical connections to and among various devices located on the surface of the board. These surface devices consist of integrated circuits and discrete passive devices, such as capacitors, resistors and inductors, and the like. The discrete passive devices occupy a high percentage of the surface area of the complete PCB. Therefore, in order to increase the available surface of the PCBs, there have been a variety of past efforts to locate passive devices, including capacitors, in a embedded, or subsurface, configuration within the board. When passive devices are in such a configuration, they are known collectively and individually in the art as “integral passives.” A capacitor designed for disposition within (between the lamina) of a PCB is called an “integral capacitor” and provides “integral capacitance.” If integral capacitive devices are to result in significant contributions to the overall power operations in integrated circuits, advances in the energy storage capabilities of these devices must be made.

There have been past attempts to provide integral capacitance. One example of an invention providing for integral capacitance is U.S. Pat. No. 5,079,069 to Howard, et al., where a dielectric sheet is sandwiched between conducting sheets to provide a layer of integral capacitance. Currently in such configurations the materials consist of conventional PCB laminate resins such as epoxy, and provide a dielectric sheet with a dielectric constant of approximately 4.5. With thicknesses of approximately 2 mils, such material can provide planar capacitance values of approximately 500 picofarads per square inch. However, many applications require capacitance values much greater than 500 picofarads per square inch and therefore other approaches must provide capacitance layers having higher planar capacitance values.

For a fixed capacitor area, only two approaches are available for increasing the planar capacitance (capacitance/area) of an integral capacitor. First, higher dielectric constant materials can be used. Second, the thickness of the dielectric can be reduced. These constraints are reflected in the following formula, known to the art, for capacitance per area:

Cₚ/A=(εε₀)/t

where: Cₚ=capacitance, A=area of capacitor, ε=dielectric constant of laminate, ε₀=dielectric constant of vacuum, and t=thickness of the dielectric.

Prior efforts in this regard have sought to provide a high capacitance core using laminate with a filler having a high dielectric constant. As an example, U.S. Pat. No. 5,162,977 suggests how to enhance the capacitance of a dielectric layer using pre-fired and ground ceramic nanopowder, and purports to teach how to produce capacitance values that are four orders of magnitude greater than those achieved simply using epoxy dielectrics. However, using pre-fired and ground ceramic nanopowders in the dielectric layer poses obstacles for the formation of vias (holes permitting electronic communication between layers of a laminated PCB). Pre-fired and ground ceramic nanopowder particles have a typical dimension in the range of 500-20,000 nm. Furthermore, the particle distribution in this range is generally rather broad, meaning that there could be a 10,000 nm particle alongside a 500 nm particle. The distribution within the dielectric layer of particles of different size often presents major obstacles to microvia formation, due to the presence of the larger particles. Another problem associated with pre-fired ceramic nanopowders is the ability for the dielectric layer to withstand substantial voltage without breakdown occurring across the layer. Typically, capacitance layers within a PCB are expected to hold off at least 300 V in order to qualify as a reliable component for PCB construction. The presence of the comparatively larger ceramic particles in pre-fired ceramic nanopowders within a capacitance layer prevents ultrathin layers from being used because the boundaries of contiguous large particles provide a path for voltage breakdown. This is doubly unfortunate because, as indicated by the equation above, greater planar capacitance may also be achieved by reducing the thickness of the dielectric layer—with the thinness limited by the size of the particles therein. Accordingly, any process which uniformly disperses very fine uniform dielectric nanopowders within a binder, such as epoxy, leads to capacitance layers which are more compatible with desired microvia formations and can withstand high voltages for thinner layers.

Most commercially available dielectric powders, such as metal titanate-based powders, are produced by a high-temperature, solid-state reaction of a mixture of the appropriate stoichiometric amounts of the oxides or oxide precursors (e.g., carbonates, hydroxides or nitrates) of barium, calcium, titanium, and the like. In such calcination processes, the reactants are wet milled to accomplish an intimate mixture. The resulting slurry is dried and fired at elevated temperatures, as high as 1300° C., to attain the desired solid state reactions. Thereafter, the fired product is milled to produce a powder.

Although the pre-fired and ground dielectric formulations produced by solid phase reactions are acceptable for many electrical applications, they suffer from several disadvantages. First, the milling step serves as a source of contaminants that can adversely affect electrical properties. Second, the milled product consists of irregularly shaped fractured aggregates that are large in size and possess a wide particle size distribution, 500-20,000 nm. Consequently, films produced using these powders are limited to thicknesses greater than the size of the largest particle. Thirdly, powder suspensions or composites produced using pre-fired ground ceramic powders must be used immediately after dispersion, due to the high sedimentation rates associated with large particles. The stable crystalline phase of barium titanate for particles greater than 200 nm is tetragonal and, at elevated temperatures, a large increase in dielectric constant occurs due to a phase transition.

A need remains for a method and apparatus for providing integral capacitors that employ improved materials to allow for thinner, purer, dielectric layers to boost capacitance and permit reliable creation of microvias.

### SUMMARY OF THE INVENTION (DISCLOSURE OF THE INVENTION)

A primary object of the present invention is to provide a dielectric substrate that has a dielectric constant that varies little over a wide temperature range.

Another object of the present invention is to provide a dielectric layer that includes a non-sintered particular material.

An additional object of the present invention is to provide a capacitor laminate including a dielectric sheet having an essentially unchanging dielectric constant which is located between conductive foil layers.

A primary advantage of the present invention is a composite comprising at least one organic polymer having a T_{g} greater than about 140° C., and at least one ferroelectric particle filler. The organic polymer and ferroelectric particles are chosen to produce a composite having a dielectric constant that varies less than 15% when the composite is subjected to temperatures ranging from −55 to 125° C.

Another advantage of the present invention is that a capacitor laminate comprising a composite of the invention can be formed into a sheet and having a top surface and a bottom surface. The capacitor laminate includes a first conductive layer associated with the composite top surface, and a second conductive layer associated with the composite bottom surface.

An additional advantage of the present invention is the enablement of multi-layer printed wiring boards wherein at least one layer comprises a capacitor laminate of this invention.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a cross sectional view of an integral capacitor apparatus prepared according to the invention;

FIG. 2 is an enlarged cross section of the dielectric layer portion of the apparatus shown in FIG. 1, illustrating the dispersal of the nanopowder in the bonding material matrix;

FIG. 3 is a further enlarged view of the components shown in FIG. 2;

FIG. 4 is a schematic flowchart illustrating some principal steps of one embodiment of the method of the invention;

FIG. 5 is a schematic flowchart illustrating some principal steps of another embodiment of the method of the invention;

FIG. 6 is a schematic flowchart illustrating some principal steps of yet another embodiment of the method of the invention.

FIG. 7 is a plot showing the effect of temperatures ranging from −55 to 125° C. on the measure dielectric constant of composites prepared according to Example 1;

FIG. 8 is an electron micrograph depicting barium titanate particles manufactured by a non-refractory chemical precipitation method and having a uniform particle size of approximately 50 nm;

FIG. 9 is an electron micrograph of conventionally milled barium titanate particles that were prepared by a refractory process.

FIG. 10 is a graph of typical size distributions of the particles depicted in FIGS. 8 and 9.

### DESCRIPTION OF THE PREFERRED EMBODIMENTS

### BEST MODES FOR CARRYING OUT THE INVENTION

The present invention is of dielectric substrate materials comprising at least one organic polymer and at least one filler wherein the dielectric constant of the laminate varies less than 15% when the composite is subjected to temperatures ranging from −55 to 125° C. The present invention includes capacitor laminates and multilayer printed circuit boards including capacitor laminates prepared from the dielectric substrate materials of this invention.

The capacitance of the dielectric layer varies depending upon factors such as the layer dielectric constant, thickness and area according to the following equation:

Cₚ/A=ε/τ

Because the area (A) is generally constant, the only way to vary capacitance, Cₚ, is to vary the substrate dielectric constant (ε) or thickness (τ). Furthermore since decreasing the thickness (τ) of the laminate becomes difficult below about 1 mil, it becomes important to control capacitance by choosing a dielectric substrate composition with the desired dielectric constant.

A further complicating factor is that the substrate dielectric constant (ε), and thus Cₚ, can vary significantly over a range of temperatures. Dielectric substrates are considered to have performance or “X7R” performance when the dielectric constant changes±15% over the 180° C. temperature range of from −55 to 125° C. An important aspect of this invention is our discovery that the dielectric substrates that include non-refractory ferroelectric particles exhibit a high and vary stable dielectric constant over wide ranging temperatures.

The term “non-refractory ferroelectric particles” is used herein to refer to particles made from one or more ferroelectric materials. Preferred ferroelectric materials include barium titanate, strontium titanate, barium neodymium titanate, barium strontium titanate, magnesium zirconate, titanium dioxide, calcium titanate, barium magnesium titanate, lead zirconium titanate and mixtures thereof.

The ferroelectric particles useful in the present invention may have particle size ranging from about 20 to about 150 nanometers. It is preferred that the particles are essentially all nanoparticles which means that the particles have a particle size of less than 100 nanometers and preferably a particle size of about 50 nanometers. It is also preferred that at least 80% of the ferroelectric particles have a size ranging from 20 to 100 nanometers and preferably from 40-60 nanometers.

The ferroelectric particles useful in this invention are preferably manufactured by a non-refractory process such as a precipitation process. Most preferred non-refractory particles are 50 nanometer barium or strontium titanate nanoparticles manufactured by TPL, Inc. What is not included within the scope of non-refractory ferroelectric particles are those particles that are produced by a heating or sintering process.

The ferroelectric particles are combined with at least one polymer to form dielectric layers. The ferroelectric particles may be present in the dielectric layer in an amount ranging from about 10 to about 60 vol % and preferably from about 15 to 50 vol % and most preferably from about 20 to 40 vol % of the dielectric layer with the remainder of the dielectric layer comprising one or more resin systems.

The ferroelectric particles are preferably combined with one or more resins that are commonly used to manufacture dielectric printed circuit board layers. The resins may include material such as silicone resins, cyanate ester resins, epoxy resins, polyamide resins, Kapton material, bismaleimide triazine resins, urethane resins, mixtures of resins and any other resins that are useful in manufacturing dielectric substrate materials. The resin is preferably a high T_{g} resin. By high T_{g}, it is meant that the resin system used should have a cured T_{g} greater than about 140° C. It is more preferred that the resin T_{g} be in excess of 160° C. and most preferably in excess of 180° C. A preferred resin system is 406-N Resin manufactured by AlliedSignal Inc.

The dielectric layers of this invention are manufactured by combining the appropriate amount of ferroelectric particles with the desired resin. The resin/ferroelectric particle resin mixture is then coated onto a conductive metal layer. The ferroelectric particle containing resin is then dried to remove solvent from the resin.

The dielectric substrates of this invention are useful for manufacturing capacitor laminates. The capacitor laminate of this invention includes a dielectric layer described above comprising ferroelectric particles, a first conductive metal layer associated with the dielectric layer top surface and a second conductive metal layer associated with the dielectric layer bottom surface. Capacitor laminates may be manufactured by any methods that are known in the art, for example, the U.S. Pat. No. 5,155,655, which is incorporated herein by reference. In another method, capacitor laminates having a top conductive metal surface and a bottom conductive metal surface separated by a ferroelectric particle-containing resin are manufactured by: (i) applying ferroelectric particle-containing resin mixture to the surface of a conductive metal foil; and (ii) applying a second layer of the conductive metal to the exposed resin to sandwich the ferroelectric particle containing resin between the conductive metal layers. Alternatively, a second ferroelectric particle/resin coated conductive metal can be applied to the first ferroelectric particle-containing resin coated conductive metal to create a sandwich wherein the ferroelectric particle-containing resin is located between the two conductive metal layers. Once formed, the capacitor precursor is laminated at appropriate temperatures and pressures in order to cure the ferroelectric particle-containing resin. The curing temperatures and pressures will range from about 250 to about 3500 and the pressures will vary from about 100 to about 1500 psi.

Conductive metal layers may be applied to the top surface and bottom surface of the dielectric substrate sheet by sputtering, by electrodeposition or by adhering a conductive metal film or foil to a dielectric sheet top surface and bottom surface. In order to ensure adhesion between the conductive layer and the dielectric layer, the surface of the conductive metal or surface of the dielectric layer may be modified or roughened to improve adhesion of the metal layer to the top and bottom surfaces of the dielectric layer. The first and second conductive layers will typically have a thickness ranging from 9 to about 105 microns. It is preferred that the first and second conductive metal layers are copper foil layers having a thickness of from 17 to about 70 microns and most preferably a thickness of about 35 microns. It is preferred that the conductive metal layers used in the capacitor dielectric are copper foil layers. Most preferably, both conductive metal layers will be double treated copper foil layers manufactured by Oak Mitsui, Gould or Circuit Foils.

The dielectric layer may include an optional second filler material in order to impart strength to the dielectric layer. Examples of the second filler materials include woven or non-woven materials such as quartz, silica glass, electronic grade glass and ceramic and polymers such as aramids, liquid crystal polymers, aromatic polyamides, or polyesters, particulate materials such as ceramic polymers, and other fillers and reinforcing material that are commonly used to manufacture printed wiring board substrate. The optional second filler material my be present in the dielectric layer in an amount ranging from about 20 to 70 wt % and preferably from an amount ranging from about 35 to about 65 wt %.

The dielectric materials of the invention may include other optional ingredients that are commonly used in the manufacture of dielectric layers. For example, the dielectric particles and/or the second filler material can include a binding agent to include the bond between the filler and the resin material in order to strengthen the dielectric layer. In addition, the resin compositions useful in the invention may include coupling agents such as silane coupling agents, zirconates and titanates. In addition, the resin composition useful in this invention may include surfactants and wetting agents to control particle agglomeration or coated surface appearance.

The compositions of the invention may be made into various articles. For instance, the composites may be shaped into films, sheets, plaques, disks and other flat shapes which are particularly useful as substrates in electronics such as printed wiring boards. The composites may also be manufactured into three dimensional shapes. The composites may be shaped by any methods known in the art such as extrusion, injection molding and compression molding.

The dielectric layers manufactured using the resin/ferroelectric particle of the invention preferably will have a thickness of from about 5 to about 60 microns. At these thicknesses the layers will have a capacitance from about 2100 to about 25000 pF/in². Preferred dielectric layers will have a thickness ranging from about 20 to about 40 microns and the capacitance from about 3100 to about 6300 pF/in² based upon a standard area.

An important property of the capacitor laminates of this invention is the breakdown voltage. The capacitor laminates of this invention have an extremely high breakdown voltage in comparison to filled and non-filled capacitor laminates of the prior art. It is preferred that the capacitor laminates of this invention have a breakdown voltage that exceeds 2000 volts/mil and preferably that exceeds 2500 volts/mil.

The capacitor laminates manufactured using the dielectric materials of the invention can be stacked and interconnected so that multiple layers are present in the printed wiring board. The layers may have different dielectric constants, different capacitance values and different thicknesses to form substrates for high density electronic packages such as single chip and multi-chip modules.

The present invention is further of methods and means for providing integral capacitance within printed circuit boards. The invention provides a method for producing a high capacitance core element for integral inclusion in a printed circuit board comprising the steps of preparing a composite mixture by mixing a bonding matrix material with a slurry comprising a suspension of hydrothermally prepared nanopowder; forming the composite mixture into a dielectric layer; and disposing the dielectric layer between two conductive layers. The method optionally further comprises the step of dispersing the hydrothermally prepared nanopowder in an organic solvent. The step of dispersing the hydrothermally prepared nanopowder may comprise dispersing the powder in an initial volumetric ratio of between about 20 percent and about 40 percent powder by volume. The method may also further comprise the step of subjecting the nanopowder and the solvent to ultrasonic energy, or the step of milling the nanopowder and the solvent. Further, a surfactant may be mixed with the nanopowder and solvent.

The step of mixing a bonding matrix material preferably comprises mixing a polymer to form a homogenous nanopowder-polymer-solvent suspension. Also, the invention may further comprise the step of curing the composite mixture to produce a dielectric layer having between about 40 percent and about 55 percent nanopowder by volume.

The step of forming the composite mixture into a dielectric layer preferably comprises impregnating a fiberglass sheet with the composite mixture, and the step of forming the composite mixture into a dielectric layer may comprise selecting a member from the group consisting of extruding, spraying, rolling, dipping, and casting the composite mixture.

The step of disposing a conductive layer preferably comprises laminating a conductive foil onto the cured dielectric layer. Alternatively, the step of disposing a conductive layer comprises the steps of: placing the composite mixture upon a conductive foil, and then curing the dielectric layer. Or, the step of disposing a conductive layer may comprise metallizing the side of the dielectric layer, such as by evaporating, sputtering, or chemical vapor depositing a conductive material upon the dielectric layer.

Highly efficient capacitance can be provided integrally within a PCB through the utility of the invention by permitting the incorporation of one or more ultra-thin dielectric layers which resist the undesirable voltage breakdown which besets known integral capacitance devices. Thus, in the present invention, a method is provided for supplying integral capacitance using very fine, uniform dielectric nanopowders within a binder, such that thinner, higher capacitance, layers are obtained. These layers hold off required test voltages, and yet may be successfully penetrated with microvias.

In the present invention, a finer dielectric powder is used, a powder having an unconventionally narrow particle size distribution. The finer powder preferably is produced using a low-temperature chemical precipitation method. The method, known in the art as “a hydrothermal process”, has been utilized in manufacturing contexts besides the production of dielectric materials for use in integral capacitors, for example in the production of certain industrial cements. Thus the general hydrothermal process for creating powders is available to one skilled in the art, for example, in U.S. Pat. No. 4,764,493 to Lilley, et al. However, hydrothermally prepared nanopowders have not previously been used to produce composite dielectric layers in the manner disclosed herein, and their use in the invention avoids many of the disadvantages associated with the pre-fired and ground nanopowders commonly employed in the art of capacitor construction.

In the case of barium titanate, for example, titania or a titanium alkoxide is reacted with barium hydroxide solvent to produce a product which possesses high density, high purity, controlled stoichiometry, small particle size and narrow particle size distribution. Reactions are typically performed at temperatures less than 100° C. to produce barium titanate with cubic crystallinity. Reaction conditions can be tailored to produced powders of appropriate compositions, depending on the dielectric application, with a mean primary particle size ranging from 10-200 nm with size deviations less than 20%. Preferably, such hydrothermal process prepared barium titanate powders are employed in the present invention.

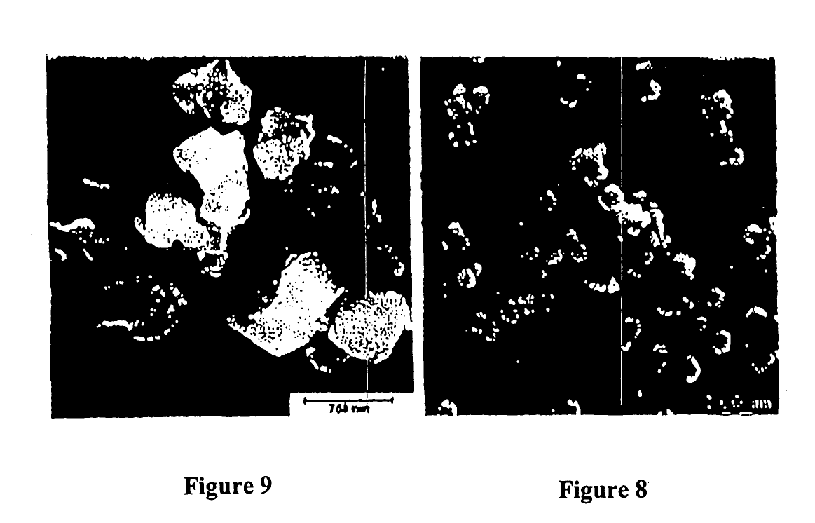

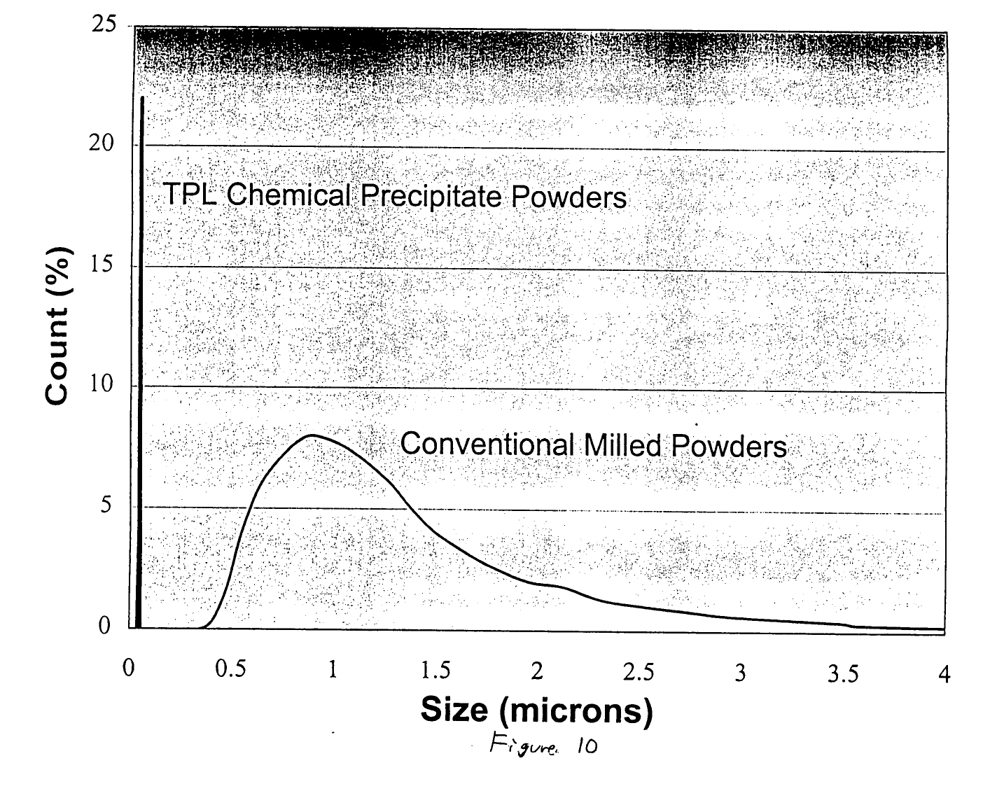

The difference in size distribution between hydrothermally prepared nanopowders (FIG. 8) and conventionally milled powders (FIG. 9) is depicted in FIG. 10. The minimum size of the milled particles is an order of magnitude larger than the size of the chemically precipitated particles, which are also greatly more homogeneous in size. Milling cannot produce particles as small in size or with such a narrow size distribution.

Hydrothermally prepared powders offer several advantages, germane to the production of integral capacitors, over conventionally produced powders. First, because composite film thickness is proportional to powder particle size, and the specific capacitance is inversely proportional to film thickness, a powder with smaller particle size allows for films to be produced with both higher uniformity and dramatically higher specific capacitance. Second, with the diameter of vias approaching 20,000 nm, producing such vias in composite films incorporating hydrothermally prepared dielectric powders is possible. Third, hydrothermal nanopowders are sufficiently small to remain in uniform suspensions or composite slurries without sedimentation, allowing material preparation to occur independently of producing a dielectric layer. Lastly, nanopowders in the desired size range of 20-150 nm, for example barium titanate powders formed hydrothermally, possess a cubic structure and thus do not undergo phase transition at the temperatures which produce large increases in dielectric constant for conventionally milled, pre-fired powders. This phase stability means that the dielectric properties of hydrothermal nanopowders remain stable over a broad range of temperatures, preferably −55 to 125° C. In K. Uchino et al., “Particle/Grain Size Dependence of Ferroelectricity”, published in Ceramic Dielectrics (date unknown), incorporated herein by reference, the authors clearly show the cubic structure of sub-100 nm particles and the corresponding elimination of the Curie temperature, as well as a dielectric constant which dramatically increases in both magnitude and temperature stability as the grain size is decreased, making such particles far superior to the approximately half-micron to micron sized conventionally milled particles.

The invention includes alternative processes for producing a high capacitance core element for integral inclusion in a PCB device. A hydrothermally prepared powder, preferably barium titanate powder, with particle size between 10-200 nm preferably is used in all embodiments. In one embodiment, the process of the invention includes forming a dielectric layer consisting of a fiberglass sheet impregnated with a nanopowder-loaded bonding composite, and then sandwiching the dielectric layer between two conductive layers. Alternatively, the nanopowder-loaded composite may be placed onto a conductive substrate, and a top conductive layer formed by coating a conductor, such as by metallization (e.g., through metal evaporation), upon the composite dielectric layer. Or, a dielectric layer comprised of the nanopowder-loaded composite may be formed and then two conductive layers deposited on both sides thereof by metallization, such as through evaporation.

In all embodiments, a slurry is prepared by dispersing the nanopowder, preferably a hydrothermally prepared powder, most preferably a barium titanate nanopowder, in an organic based or aqueous solvent compatible with the bonding material. Suitable solvents for the practice of the invention include methyl ethyl ketone or dimethyl formamide, or a combination of these two. Preferably the slurry is a colloidal suspension, where the powders are prepared to maintain particles apart from each other and to inhibit particle/particle interactions. Powders are mixed into the solvent using sonication, or milling, and coated with surface active molecules (surfactant) in order to minimize powder particle agglomeration. The surfactant preferably but not necessarily is a non-ionic phosphate ester. The polymer matrix material is then added to the colloidal suspension slurry to form a powder-polymer-solvent composite suspension. A polymer epoxy well suited for use as the bonding material in the invention is the 406 Epoxy Resin available from Allied Signal Corporation, although other resins can suffice.

The composite mixtures are then used to create high dielectric constant layers for use as capacitors. In the preferred embodiment of the invention, the solvent/powder slurries have an initial volumetric ratio of between about 20 percent and about 40 percent powder by volume, with higher powder volumes resulting in increased viscosity. Viscosity thus can be controlled to suit the solvent/powder composition for different possible application methods, e.g., casting versus extrusion. The solvent/powder slurry is mixed with the bonding material, and the resulting mixture is cured to drive off solvent and set the matrix. The resulting finished (cured) dielectric layer according to the invention preferably has a volumetric powder/matrix ratio of between about 40 percent and about 55 percent powder by volume. The dielectric constant of a film may be controlled though varying volume fractions of the powder and the bonding material, with higher percent volumes of powder yielding increased dielectric constants at the expense of decreasing mechanical strength. Percent volumes of nanopowders in excess of about 55 percent exhibit undesirable brittleness.

In one embodiment of the invention, a capacitor for integration into a PCB is created by impregnating fiberglass sheets with the composite material and then laminating the impregnated sheet between two conductive layers, such as copper foil. The impregnated fiberglass sheet typically has a thickness ranging between 2.0 mil and 6.0 mil. Preferably, the fiberglass sheet is submerged in and passed through a bath of the composite mixture, and the nanopowder particles are permitted to penetrate into the interstitial spaces of the fiberglass sheet to impregnate it with the composite mixture. An advantage of the invention is that the nano-powders are sufficiently small to freely enter between the glass fibers, thoroughly saturating the fiberglass sheet. This results in a dielectric layer of desirable strength and resiliency which also features suitable dielectric qualities.

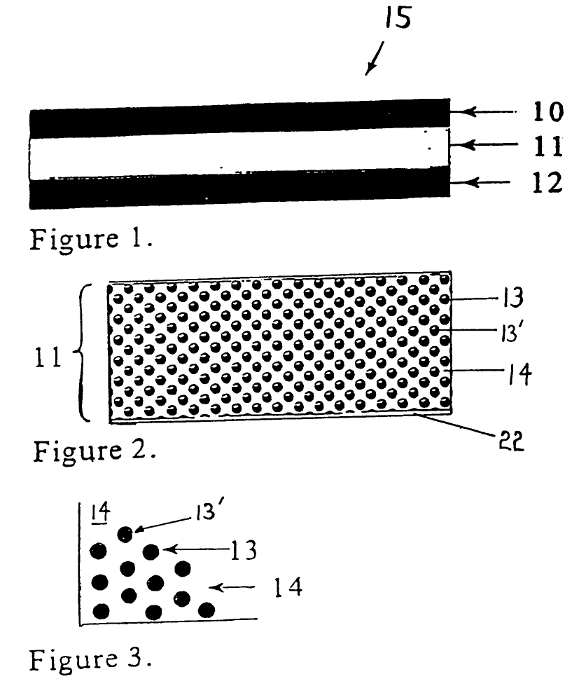

The bonding material used in the composite mixture preferably is an epoxy resin, while the ceramic used is a high dielectric constant barium titanate powder produced using a hydrothermal process. Reference is made to FIG. 1, illustrating an integral capacitance apparatus 15 according to the invention. Conductive layers 10 and 12, such as copper foils, have the dielectric layer 11, such as a composite-impregnated fiberglass sheet, disposed there between. FIG. 2 is an enlarged cross sectional view of the composite dielectric layer 11 showing that individual hydrothermally prepared barium titanate nanopowders 13,13′ are uniformly dispersed throughout the bonding matrix 14, which has impregnated the fiberglass sheet 22. FIG. 3 shows an enlarged view of a portion of the dielectric 11, without the fiberglass sheet, where individual hydrothermally prepared nanopowders 13,13′ are disposed within the epoxy matrix 14 at an average distance of separation which permits ready provision of microvias.

In this first embodiment of the invention, the composite-impregnated fiberglass sheet comprises the dielectric layer 11. Subsequent to the production of the dielectric layer 11 as described above, the conductive layers 10 and 12 are disposed upon one, or usually two sides, of the dielectric layer. This may be done in a lamination press, wherein the conductive layers 10,12 (e.g., thin copper sheets, each about 1 or 2 mils thick) are pressed against the dielectric layer 11, and the entire sandwiched assembly heated to cause the polymer matrix in the dialectic layer 11 to bond to the conductive sheets. Accordingly, in many applications of the invention, it is desirable to employ a polymer with a relatively low glass transition temperature so that conventional lamination presses can induce the bonding between layer 11 and the conduction sheets 10,12. Besides the foregoing lamination manner of disposing the conductive layers upon the dielectric layer, alternative modes such as attachment of the conductive layers to the dielectric layer using other adhesive materials are within the scope of the invention.

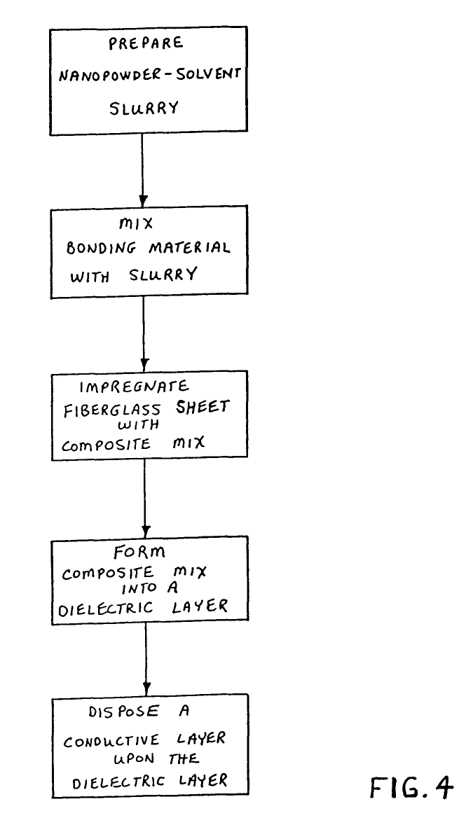

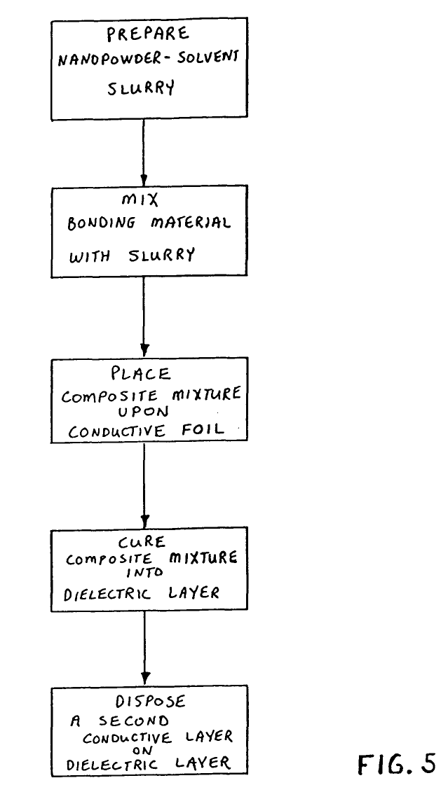

The method for making the apparatus of this first embodiment is further explained with reference to FIG. 4. Again, in one step, a slurry is prepared by dispersing a hydrothermally prepared nanopowder in a solvent. The dispersal may be accomplished with sonication, or by any other suitable means. Preferably, a surfactant is supplied to the suspension to create a colloidal suspension of the nanopowder in the solvent. Preferably, the bonding material, preferably an epoxy, is mixed with the slurry to prepare a composite mixture of the solvent and nanopowder with the bonding material. The resulting composite mix then is impregnated into a porous supporting laminate, preferably a fiberglass sheet, so that the composite mix and the fiberglass sheet effectively form a dielectric layer. Once the composite has hardened, as by curing, a conductive layer is disposed upon one or preferably both sides of the dielectric layer. Preferably, in this embodiment of the method, the disposition of the conductive layer or layers is accomplished by lamination, in which the three layers are pressed together under conditions of elevated temperature and pressure.

An advantage of the invention is that the use of nano-powders allows microvias to be drilled through the dielectric layer 11 with the use of micro lasers. A typical micro laser beam, encountering a nano-powder particle, is able to destroy or displace the small particle and thereby maintain the straightness and quality of the microvia. In known dielectric layers including conventional powders, the size of the ceramic particles can interfere with microvia drilling with micro lasers. Laser beams are scattered by the larger diameter particles, drilling is impeded, and the quality of the microvia impaired.

In a second embodiment of the invention, an integral capacitor is created by coating a conductive foil or sheet 12 with a composite mixture which includes a bonding matrix material, solvent, and hydrothermally prepared nanopowders. The preparation of the composite mixture is generally the same as previously described, that is, a nanopowder is suspended in a solvent to create a suspension slurry, and the bonding material, usually a polymer, is mixed with the slurry. Coating of a conductive foil substrate 12 such as copper is performed by physical placement of the composite mixture on the foil and subsequent removal of the solvent. For example, the uncured composite mixture may be extruded onto a conductive layer 12, and then the composite and conductive layer placed into a curing oven for about ten minutes at about 180° F. In this embodiment, no fiberglass sheet is included in the dielectric layer, rather the composite mixture is by itself cured to form the dielectric layer 11. The dielectric layer 11 thus is not as mechanically strong, but, when using powders which have mean diameters of less than 50 nm, dielectric layers as thin as one micron may be obtained. By this embodiment, therefore, integral capacitors yielding extremely high planar capacitance, for example at least 120,000 picofarads per square inch, may be constructed. Application of the uncured composite mixture preferably is accomplished by extruding, or alternatively through spraying, rolling, dipping, or casting the composite mixture onto the conductive substrate 12.

FIG. 1 may also be referred to as illustrative of this second embodiment of the apparatus. The composite dielectric layer 11 forming the dielectric film is placed or coated onto a self-supporting conductive layer 12, such as a copper foil. Subsequently, a second conductive layer 10 is applied to the other side of the dielectric layer 11, such as by press laminating a second foil, or by metal evaporation, to complete the integral capacitor construction. Again, FIG. 2 shows a cross-section of the dielectric composite layer 11, with individual hydrothermally prepared nanopowders 13,13′ uniformly dispersed throughout the binding matrix 14. FIG. 3 shows an enlarged view of the dielectric layer 11 where individual hydrothermally prepared nanopowders 13,13′ are dispersed within the binding matrix 14.

Reference to FIG. 5 provides additional information regarding the second embodiment of the method of the invention. As mentioned, this embodiment includes the steps of preparing a slurry of a nanopowder dispersed in a solvent, preferably also with a surfactant. The method includes mixing the bonding material, again preferably an epoxy, with the nanopowder-solvent suspension. After the preparation of the composite mixture by mixing the bonding matrix material with the slurry, the forming of the dielectric layer is accomplished by extruding, spraying rolling, dipping or casting the uncured composite mixture, while a conductive layer is disposed thereon by placing the uncured composite mixture upon a self-supporting conductive layer such as a copper foil or the like. The method then involves curing the composite mixture to eliminate most of the solvent, so that the dielectric layer becomes substantially solid. Thereafter, as indicated in FIG. 5, the basic method is completed with the disposing of a second conductive layer, such as a copper foil, on the other side of the dielectric layer, that is, the side of the layer that was not initially placed upon the first conductive layer. This embodiment is characterized, therefore, by the of extruding, spraying, rolling, dipping or casting of the composite mixture directly upon at least one self-supporting conductive layer such as a metal foil. This method permits the forming of extremely thin dielectric layers.

In another embodiment of the invention, a capacitor for integration is created by metallizing a self-supported composite dielectric layer 11 which includes a bonding matrix material and the hydrothermally prepared nanopowders. The composite dielectric layer 11, preferably having a thickness of at least 2.0 micron, is formed by extrusion or casting. The general process of this embodiment of invention is similar to the process of the second embodiment described, except that instead of incorporating at least one self-supporting conductive foil, at least one of the conductive layers 10 and 12 is disposed upon the dielectric layer 11 using a metal deposition process such as evaporation, sputtering or chemical vapor deposition. Thus, the third embodiment includes at least one, “metallized” conductive layer 12, and optionally both layers 10,12 are metallized layers. An advantage of metallized conductive layers 10 or 12 is that the conductive layers may be deposited with comparatively thin thicknesses, e.g., one micron or less. These thinner conductive layers 10,12 deposited on the dielectric film 11 using metallization, such as vapor deposition, reduce the amount of etching required for patterning electrodes for specific integral capacitors. Referring again to FIG. 1, the conductive layers 10 and 12 are created by evaporation or sputtering. FIG. 2 shows the cross-section of the dielectric film 11 where individual hydrothermally prepared nanopowders 13,13′ are uniformly dispersed throughout the binding matrix 14.

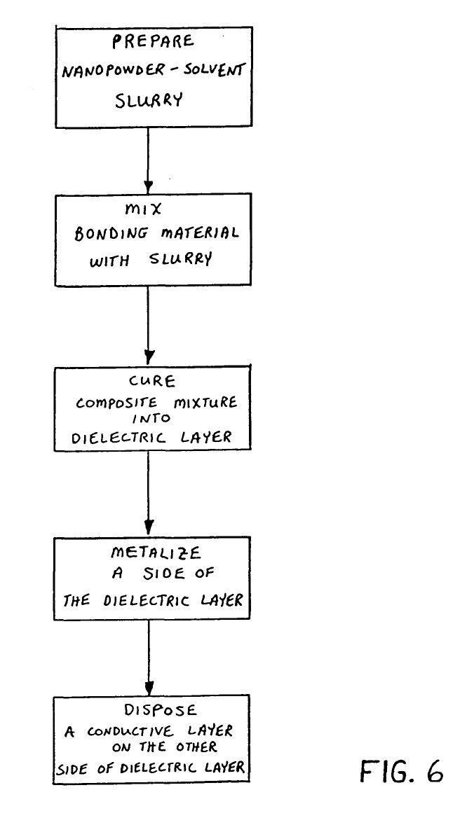

Reference is now made to FIG. 6, which generally depicts the fundamental steps of this third embodiment of the method. Again, the first two basic steps are common to the other embodiments, with the slurry very preferably involving the suspension of a hydrothermally prepared barium titanate nanopowder. The slurry is mixed with the bonding material, and the resulting composite mixture is allowed to cure to form a dielectric layer. In this embodiment, unlike the second embodiment of the method, no self-supporting conductive layers need be disposed against the dielectric layer. Rather, at least one side of the dielectric layer, and optionally both sides of the dielectric layer, are metallized, preferably by metal vapor deposition. This permits the incorporation of extremely thin conductive layers. Finally, as shown by FIG. 6, a second conductive layer is disposed upon the other side of the dielectric layer. This second conductive layer may be a self-supporting metal foil, or, as mention, may be a second metallized surface.

It is seen, therefore, that a single capacitor apparatus according to the invention typically has a composite dielectric layer 11 from about 2 mil to about 6 mil in thickness if the fiberglass sheet is used therein, and with conductive layers 10,12 each of about 1 to 2 mils thickness, for an overall apparatus thickness of between about 4 mil to about 10 mil. In alternative embodiments constructed without the inclusion of the reinforcing fiberglass sheet, the composite dielectric layer 11 can be much thinner, approaching one mil thickness, while metallized conductive layers 10,12 produced by vapor deposition or the like can also be much thinner, with corresponding resulting dramatic decreases in the total thickness (e.g., down to about six microns) of the integral capacitor, due particularly to the uniformly small diameters of the nanopowders included in the dielectric layer of the capacitor.

Also, in may applications, it may be desirable to “stack” a number of capacitors, for example from five to ten, produced according to any of the embodiments of the invention, to create a multi-capacitor component. For example, five capacitors (e.g., five dielectric layers alternately stacked between six conductive layers) may be laminated together for inclusion into a PCB.

### EXAMPLE 1

Dielectric substrates with varying resin T_{g} and varying filler compositions were prepared and tested in this Example. Specifically, the substrates included no filler, sintered and ground barium titanate filler particles, and non-refractory barium titanate filler particles.

AlliedSignal 406 Resin was used alone or combined with 50 wt % barium titanate particles to form a dielectric layer. Two forms of barium titanate particles were used; sintered barium titanate particles manufactured by TAM Ceramics, Inc., Niagara Falls, N.Y., and nonrefractory barium titanate particles manufactured by TPL, Inc., in Albuquerque, N. Mex. The sintered barium titanate particles have a primary particle size of 1 micrometer, a BET surface area of 3.3 m²/g and a dielectric constant of 3000. The nonrefractory barium strontium titanate particles had a particle size of about 0.05 micrometers, a BET surface area of 26.0 m²/g and dielectric constant of 3000.

Dielectric layers were prepared using the resin or resin/particle combination by coating a 1 oz. Double Treat (DT) copper foil manufactured by Oak Mitsui with resin/particle combination, applying a second layer of 1 oz. copper foil to sandwich the resin/particle combination between the two copper foil layers and laminating the product for about one hour at 350° F. under a pressure from 300 to 1200 psi.

Each of the three capacitors was evaluated by measuring the dielectric constant of the substrate material over a temperature range from −55° C. to 125° C. The unfilled resin exhibited a 25% change in the dielectric constant over the testing temperature range. The composite including 50 wt % sintered barium titanate particles saw a 24.2% change in the dielectric constant over the tested temperature range while the composite including 50 wt % nonrefractory barium titanate saw its dielectric constant change only 10% over the tested temperature range.

### EXAMPLE 2

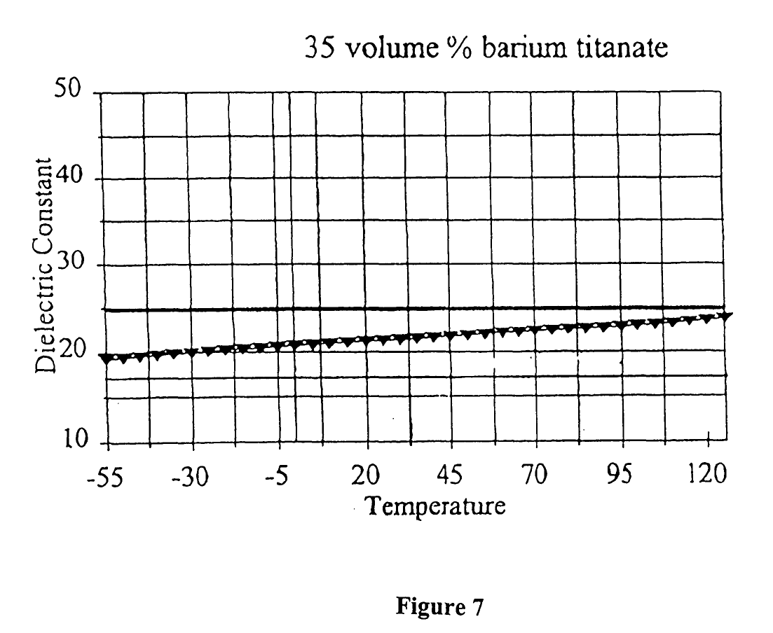

A dielectric material including 35 vol. % nonrefractory barium titanate was prepared and tested according to the method of Example 1. The change in dielectric constant over a temperature range from 55° to 125° C. was plotted and is reported in FIG. 7. From FIG. 7, it is clear that the dielectric constant changes about 10% over the temperature range. Therefore, the amount of nonrefractory barium titanate in the composition does not dramatically alter the dielectric constant stability of the resulting dielectric composition.

### EXAMPLE 3

A capacitor laminate including 35 vol. % nonrefractory barium titanate was prepared and tested according to the method of Example 1. However, the resin system used was AlliedSignal 402 Resin which has a T_{g} of 140° C. The change in dielectric constant over a temperature range of −55 to 125° C. was 27.5%.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method for producing a high capacitance core element for integral inclusion in a printed circuit board comprising the steps of:
preparing a slurry by dispersing a hydrothermally prepared nanopowder in a solvent;
preparing a composite mixture by mixing a bonding material with the slurry;
forming the composite mixture into a dielectric layer less than about 6 mil thickness; and
disposing a conductive layer upon at least one side of the dielectric layer.

2. The method of claim 1 further comprising the step of curing the dielectric layer.

3. The method of claim 1 wherein the step of preparing a slurry comprises the step of dispersing the hydrothermally prepared nanopowder in an organic solvent.

4. The method of claim 3 wherein the step of dispersing the hydrothermally prepared nanopowder comprises dispersing the powder in an initial volumetric ratio of between about 20 percent and about 40 percent powder by volume.

5. The method of claim 3 wherein the step of dispersing comprises dispersing the nanopowder in a member selected from the group consisting of methyl ethyl ketone, dimethyl formamide, and a mixture of methyl ethyl ketone and dimethyl formamide.

6. The method of claim 1 wherein the step of preparing a slurry comprises sonicating the nanopowder and the solvent.

7. The method of claim 1 wherein the step of preparing a slurry comprises milling the nanopowder and the solvent.

8. The method of claim 3 wherein the step of preparing a slurry comprises generating a colloidal suspension by mixing a surfactant with the nanopowder and solvent.

9. The method of claim 7 wherein the step of preparing a composite mixture comprises adding a polymer matrix material to the colloidal suspension to form a homogenous powder-polymer-solvent suspension.

10. The method of claim 1 wherein the steps of preparing a composite mixture and curing the dielectric layer result in a dielectric layer having between about 40 percent and about 55 percent nanopowder by volume.

11. The method of claim 1 wherein the step of forming the composite mixture into a dielectric layer comprises impregnating a fiberglass sheet with the composite mixture.

12. The method of claim 1 wherein the step of forming the composite mixture into a dielectric layer comprises selecting a member from the group consisting of extruding, spraying, rolling, dipping, and casting the composite mixture.

13. The method of claim 1 wherein the step of disposing a conductive layer comprises laminating a conductive foil onto the dielectric layer.

14. The method of claim 1 wherein the step of disposing a conductive layer comprises placing the composite mixture upon a conductive foil prior to curing the dielectric layer.

15. The method of claim 1 wherein the step of disposing a conductive layer comprises metallizing the side of the dielectric layer.

16. The method of claim 15 wherein the step of metallizing comprises evaporating, sputtering, or chemical vapor depositing a conductive material upon the dielectric layer.

17. A method for producing a high capacitance core element for integral inclusion in a printed circuit board comprising the steps of:
preparing a composite mixture by mixing a bonding matrix material with a slurry comprising a suspension of hydrothermally prepared nanopowder;
forming the composite mixture into a dielectric layer; and
disposing the dielectric layer between two conductive layers.

18. The method of claim 17 further comprising the step of dispersing the hydrothermally prepared nanopowder in an organic solvent.

19. The method of claim 18 wherein the step of dispersing the hydrothermally prepared nanopowder comprises dispersing the powder in an initial volumetric ratio of between about 20 percent and about 40 percent powder by volume.

20. The method of claim 18 further comprising the step of sonicating the nanopowder and the solvent.

21. The method of claim 18 further comprising the step of milling the nanopowder and the solvent.

22. The method of claim 17 further comprising the step of mixing a surfactant with the nanopowder and solvent.

23. The method of claim 17 wherein the step of mixing a bonding matrix material comprises mixing a polymer to form a nanopowder-polymer-solvent suspension.

24. The method of claim 17 further comprising the step of curing the composite mixture to produce a dielectric layer having between about 40 percent and about 55 percent nanopowder by volume.

25. The method of claim 17 wherein the step of forming the composite mixture into a dielectric layer comprises impregnating a fiberglass sheet with the composite mixture.

26. The method of claim 17 wherein the step of forming the composite mixture into a dielectric layer comprises selecting a member from the group consisting of extruding, spraying, rolling, dipping, and casting the composite mixture.

27. The method of claim 17 wherein the step of disposing a conductive layer comprises laminating a conductive foil onto the cured dielectric layer.

28. The method of claim 17 wherein the step of disposing a conductive layer comprises the steps of:
placing the composite mixture upon a conductive foil; and then
curing the dielectric layer.

29. The method of claim 17 wherein the step of disposing a conductive layer comprises metallizing the side of the dielectric layer.

30. The method of claim 29 wherein the step of metallizing comprises evaporating, sputtering, or chemical vapor depositing a conductive material upon the dielectric layer.

31. A dielectric material integrally included in a printed circuit board said dielectric material comprising a ferroelectric nanopowder having a cubic crystalline structure prepared using a low temperature chemical precipitation process and having particle size ranging from about 10 to 200 nanometers, a polymer resin, preferably a polymer epoxy, intermittently dispersed in the form of a film, said film disposed between two conducting layers.

32. The dielectric material of claim 31 wherein said film comprises a nanopowder/bonding agent ratio of about 30 to about 60 percent powder by volume.

33. The dielectric material of claim 31 wherein said dielectric nanopowder is barium titanate.

34. The dielectric material of claim 31 wherein said conducting layers comprise copper.

35. The dielectric material of claim 31 further comprising a surfactant, preferably a non-ionic phosphate ester.
